(19) United States
(12) Patent Application Publication
(10) Pub. No.: US 2011/0053052 A1
(43) Pub. Date: Mar. 3, 2011

(54) FUEL CELL COMPOSITE FLOW FIELD ELEMENT AND METHOD OF FORMING THE SAME

(75) Inventors: James C. Braun, Loxahatchee, FL (US); Luis Alberto Riera Arnal, Boca Raton, FL (US); Jeffery Roland Pierce, Palm Beach Shores, FL (US); Daniel A. Betts, Parkland, FL (US)

(73) Assignee: ENERFUEL, INC., West Palm Beach, FL (US)

(21) Appl. No.: 12/550,228

(22) Filed: Aug. 28, 2009

(51) Int. Cl. H01M 2/14; H01M 4/04

(52) U.S. Cl. 429/532; 29/623.4; 429/535

(57) ABSTRACT

A composite flow field element, such as a separator plate used in a high temperature air-cooled fuel cell assembly, preferably includes a metal sheet substrate of non-uniform thickness, such as a mesh, and flexible graphite layers bonded to the metal mesh substrate by an electrically conductive bonding agent.

### FIELD OF THE INVENTION

The subject invention relates to fuel cells and more particularly, to a components therefor, such as separator plates and flow field elements, and a method for producing these components.

### BACKGROUND OF THE INVENTION

A typical fuel cell system includes a power section in which one or more fuel cells generate electrical power. Each fuel cell unit may include a proton exchange member (PEM) at the center with gas diffusion layers on either side of the proton exchange member. Anode and cathode catalyst layers are respectively positioned at the inside of the gas diffusion layers. This unit is referred to as a membrane electrode assembly (MEA). Bipolar separator plates are respectively positioned on the outside of the gas diffusion layers of the membrane electrode assembly and serve to structurally support the fuel cell assembly and provide channels for the flow of fuel and oxides. This type of fuel cell is often referred to as a PEM fuel cell. It is important that the bipolar separator plates are mechanically strong, electrically and thermally conductive and impermeable to gas.

Bipolar separator plates can be formed of graphite with a multitude of flow channels machined into the plate. Such graphite separator plates can have numerous disadvantages. First, these plates are heavy and are subject to cracking as the temperature in the fuel cell is increased. Second, the cost of machining these plates from graphite negatively impacts the overall cost of the fuel cell unit.

An alternative to the machined graphite separator plate is a corrugated separator plate from a metal sheet. Corrugated metal plates eliminate the relatively expensive step of machining the flow channels in a graphite plate. This approached reduces the overall cost per square foot of the final product. However, the corrugated metal separator plates are not corrosion resistant so this alternative also becomes expensive because both sides of the corrugated metal separator plate are plated with gold or platinum to resist corrosion.

Therefore, there remains an opportunity to improve upon fuel cell flow field elements such as separator plates by eliminating the need for high-cost machined graphite plates and metal plates plated with platinum or gold and facilitate manufacture in mass production.

### SUMMARY OF THE INVENTION

It is therefore a feature of the present invention to provide fuel cell components with a lower production cost and which are easy to manufacture in mass production, while achieving desirable thermal and electrical conductivity of the fuel cell component with formability and corrosion resistance, particularly in high temperature fuel cell applications operating at over 100 degrees C.

According to aspects of the invention, a fuel cell composite flow field element can include a conductive substrate sheet having a series of recesses interspaced among outer surface nodes, thereby providing a non-uniform thickness; an electrically conductive bonding agent applied to the substrate; and a flexible graphite layer bonded to one side or both sides of the substrate. The fuel cell composite flow field element further provides at least one flow channel.

The nodes can be substantially the same height relative to a reference plane of the substrate sheet, or some of the nodes can have different heights than the heights of other nodes relative to a reference plane of the substrate sheet. Similarly, the recesses can have substantially the same depth relative to a reference plane of the substrate sheet. Alternatively, some of the recesses can have different depths than the depths of other recesses relative to a reference plane of the substrate sheet.

The recesses can be dimples in the substrate sheet. The recesses can be through-perforations in the sheet. The substrate sheet can be a screen, in which the recesses are through holes of the screen and the nodes are provided by the webbing of the screen. The substrate sheet can be a woven mesh, in which the recesses are through holes of the mesh and the nodes are provided by the weave of the mesh. The mesh can be metal. The metal mesh can have a thickness in the range of 0.001 inches to 0.010 inches. The substrate can include metal or metal alloy. The substrate can also include woven or non-woven carbon fibers.

The bonding agent can be applied as a powder, and the bonding agent powder can be cured after application. Preferably, the bonding agent thickness is thinner on the nodes than in the recesses. The electrically conductive bonding agent can include a polymeric component and carbon particles, wherein the carbon particles are dispersed within the polymeric component. The polymeric component can include a cured thermoplastic. Preferably, the polymeric component has a continuous use temperature above 190 degrees C.

The fuel cell composite flow field element can be an MEA support plate and the flow channel can be a fluid port through the plane of the support plate. Alternatively, the fuel cell composite flow field element can be configured as a corrugated flow field insert. The flow field element can also be made into a separator plate and the flow channel can be a fluid port through the plane of the support plate.

According to another aspect of the invention, a method for making a fuel cell composite flow field element can be utilized. In the method, an electrically conductive bonding agent is applied to a flexible graphite layer. A conductive substrate sheet having a non-uniform thickness provided by a series of recesses interspaced among outer surface nodes is placed on to the flexible graphite layer. An electrically conductive bonding agent is applied to the substrate. A second flexible graphite layer covers the substrate sheet to form a composite stack.

The composite stack is cured and hot pressed. Finally, the composite stack is cooled under weight to room temperature.

The bonding agent can include a combination of PPS polymer powder (100 ppw); water (260 ppw); propylene glycol (20 ppw); wetting agent (4 ppw) and graphite (100 ppw). For a preferred application to a metal screen substrate, the minimum quantity of the bonding agent can be calculated from a webbing dimension of the screen and an opening percentage of opening area to total area of the screen. The minimum quantity of bonding agent can be calculated in mass based on the product of bonding agent cured density average, the webbing dimension, the opening percentage and substrate sheet total area.

The curing step can include heating the composite stack to about 375 degrees C. for about 35 minutes in an air circulating heating environment. The hot pressing step can include pressing the composite stack between two steel plates at about 1000 psi and about 280 degrees C. for about 30 seconds.

An advantage of the present invention is to provide a fuel cell component with high thermal and electrical conductivity that eliminates the need for high-cost machined graphite plates and metal plates plated with platinum or gold.

Another advantage of the present invention is to provide a fuel cell component that is easy to manufacture, including forming the component.

These and other features, objects and advantages of the present invention will become more apparent to one skilled in the art from the following detailed description and accompanying drawings.

### BRIEF DESCRIPTION OF THE DRAWINGS

There are shown in the drawings, embodiments which are presently preferred. It is expressly noted, however, that the invention is not limited to the precise arrangements and instrumentalities shown in the drawings.

FIG. 1 is a perspective and exploded view of a fuel cell flow filed element having a metal substrate of non-uniform thickness in the form of a mesh between a pair of flexible graphite layers, with bonding agent applied between the metal substrate and each flexible graphite layer;

FIG. 2A shows a sectional view of a fuel cell flow field element configured for use as a separator plate;

FIG. 2B shows a section view of a fuel cell flow field element corrugated for use as a flow field insert;

FIG. 3A is a perspective view of a conductive substrate of non-uniform thickness in the form of a screen;

FIG. 3B is a partial sectional view, not to scale, of the substrate in FIG. 3A positioned in a composite stack;

FIG. 4A is a perspective view of a conductive substrate of non-uniform thickness in the form of a woven mesh;

FIG. 4B is a partial sectional view, not to scale, of the substrate in FIG. 4A positioned in a composite stack;

FIG. 5A is a perspective view of a conductive substrate of non-uniform thickness in the form of a perforated plate;

FIG. 5B is a partial sectional view, not to scale, of the substrate in FIG. 5A positioned in a composite stack;

FIG. 6A is a perspective view of a conductive substrate of non-uniform thickness in the form of a dimpled plate;

FIG. 6B is a partial sectional view, not to scale, of the substrate in FIG. 6A positioned in a composite stack;

FIG. 7A is a perspective view of a conductive substrate of non-uniform thickness in the form of a crinkled mesh;

FIG. 7B is a partial sectional view, not to scale, of the substrate in FIG. 7A positioned in a composite stack;

FIG. 8A is a perspective view of a conductive substrate of non-uniform thickness in the form of a roughened or etched film or plate;

FIG. 8B is a partial sectional view, not to scale, of the substrate in FIG. 8A;

FIG. 9 illustrates a process for making a fuel cell flow field element;

FIG. 10 is a graph of electrical and thermal properties of various separator plates as a function of thickness of the flexible graphite layers;

FIG. 11 shows a BASF polarization curve and voltage drop vs. current density of corrugated laminate samples for use in a 4-cell fuel cell;

FIG. 12 is a graph of test results for an air-cooled 8-cell stack with metal plates.

FIG. 13 is a graph of test results for a 3 kW air-cooled 80-cell stack with metal plates.

FIG. 14 is a graph of test results for an air-cooled 4-cell stack with plates using composite stacks according to the invention.

FIG. 15 is a graph showing single cell performance as a function of cell temperature with H2/Air.

### DETAILED DESCRIPTION OF EMBODIMENTS OF THE INVENTION

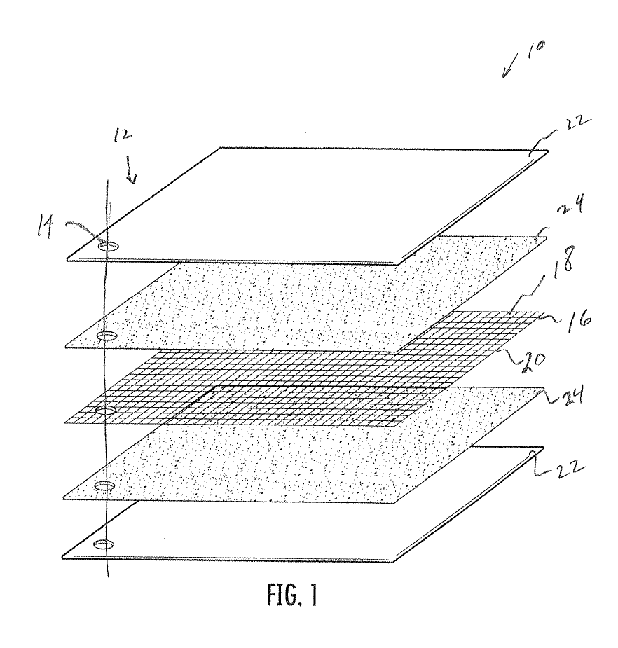

Embodiments of the invention are directed to fuel cell composite flow field elements and to methods of manufacturing these flow field elements adapted to improve the combination of thermal and electrical conductivity with formability. Aspects of the invention will be explained in connection with various flow field element configurations, but the detailed description is intended only as exemplary. Embodiments of the invention are shown in FIGS. 1-9, but the present invention is not limited to the illustrated structure or application.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

The fuel cell composite flow field element can take on a number of forms and applications in a fuel cell. The flow field element can be configured as an MEA support plate, a corrugated flow field insert or a separator plate, to name a few examples. As shown in FIG. 1, the composite flow field element 10 includes a composite stack 12 and provides at least one flow channel 14. The flow field channel 14 as shown provides for through plane flow for such applications as fuel and oxidant supply and exhaust in a fuel cell stack. There can be more than one flow field channel, and when multiple flow field channels are employed, they can be the same or they can be different in size, shape and conformation. A through plane flow field channel can be located at various locations on the composite stack 12 within the stack perimeter or on an edge of the stack 12.

According to an aspect of the invention, the composite stack 12 includes a conductive substrate sheet having non-uniform thickness, such as a screen 16. As used herein, “non-uniform thickness” means that the substrate sheet has a series of recesses interspaced among outer surface nodes. This construction results in a variation in the thickness of the sheet. The recesses refer to depressions and can include through holes in the sheet, while the nodes represent the sheet surfaces between the recesses. The nodes may be flat and planar or may take on various heights relative to a reference plane. The term “sheet” as used to describe the substrate does not limit the substrate to a planar or flat configuration as the substrate and the composite stack may be formed in other shapes, including corrugations, bends and creases.

The non-uniform thickness can be provided in several different arrangements. As shown in FIG. 1, a preferred construction of the sheet is in the form of a mesh or screen 16, in which the through-holes 18 (only one of which is reference numbered to aid in illustration) repeated throughout the screen 16 form the recesses and the webbing 20 of the screen 16 present the nodes.

In addition to the substrate sheet of non-uniform thickness, the composite stack 12 further includes one, and preferably two, flexible graphite layers 22 that cover the substrate sheet. The flexible graphite layers 22 provide corrosion resistance to the composite stack 12. The composite stack 12 further includes an electrically conductive bonding agent 24 that is applied between the substrate sheet, such as the screen 16, and the flexible graphite layers 22. The recesses and nodes of the substrate sheet of non-uniform thickness enables the conductive bonding agent 24 to contact a greater surface area of the substrate sheet when compared to a sheet without nodes and recesses and to allow projection nodes of the substrate sheet to contact or be placed closer to the graphite layers 22. These characteristics of the composite stack 12 further enhance the thermal and electrical conductivity of the flow field element 10.

The conductive substrate of non-uniform thickness can include any suitable conductive material, but is preferably a metal or metal alloy. For example, the substrate of non-uniform thickness material can include a metal mesh, such as stainless steel mesh; a creased or crinkled metal foil, such as stainless steel foil; or woven or non-woven carbon fibers.

The substrate of non-uniform thickness in the form of a mesh 16 can include any fine mesh, wire cloth or screen having shape retaining properties. For example, the mesh 16 can include woven metal wires with small open spaces in between. The open spaces of mesh allow for a continuous network of conductive bonding agent 24 to be deposited throughout the layer thickness, preventing large flakes from peeling off of the metal surface of the substrate.

Mesh sizes can include between 80×80 to 600×600. Rectangular openings such as 100×150 mesh are suitable for roll-to-roll impregnation processes, where the web speed and direction can affect the extent of impregnation.

The mechanical properties of 150×150 mesh with about 30% open area are suitable to provide a compressive spring constant that matches the desired compressive load for high temperature PEM membranes. Excessive force during compression of the fuel cells reduces the life of the MEAs. Ideally, the compressive stress exerted on the MEA should remain below 150 psi, and more specifically below 100 psi, for compressive strain in the range of 0.0005 inches to 0.002 inches. It is possible to obtain compressive stress less than 50 psi for strains of up to 0.002 inches with a suitable choice of the metal reinforcement.

The percent open area of the mesh can range between 20% to 80%. The opening size should allow for the impregnation of the mesh with the conductive bonding agent. Typical opening sizes range from 0.0005 inches to 0.010 inches. A smaller opening can be used with a lower viscosity conductive adhesive. Openings in the range of 0.001 inches to 0.005 inches provide an optimum range for developing a strong network of the conductive adhesive material within the reinforcing layer.

A metal mesh provides several advantages, including that the increased surface area of the metal substrate of non-uniform thickness (and thus the increased contact area with the conductive bonding agent) provides for lower through plane electrical resistance compared with a metal foil reinforcing layer. See Table 4 below.

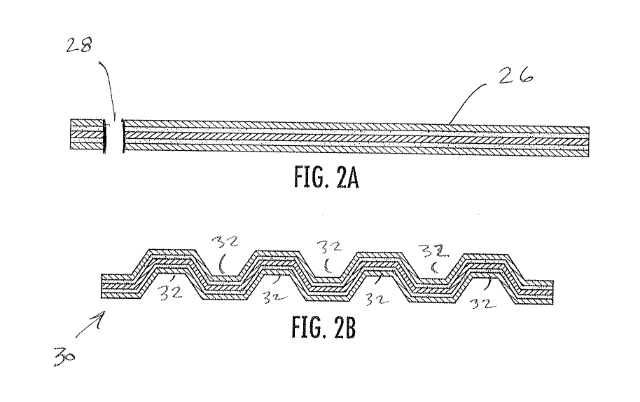

A metal mesh or a creased or crinkled metal foil provide several advantages, including the ability to form the composite into a three-dimensional structure using mechanical bending, such as through corrugation. Corrugation of thin unreinforced flexible graphite is otherwise not possible, as the mechanical bending stresses cause an unreinforced flexible graphite sheet to easily tear. Furthermore, the flexible graphite would not have sufficient strength to retain a corrugated shape under the compressive loads generated during fuel cell stack assembly. As shown in FIG. 2A, the composite stack 26 can used in a planar arrangement with a fluid channel 28 formed through the plane of the stack 26. Alternatively, as shown in FIG. 2B, a composite stack 30 can be formed to provide corrugations, providing flow channels 32. The metal substrate foil thickness can range from 0.001 inches to 0.010 inches. Corrugations using 0.002 inch thick metal foil have satisfactory mechanical properties, and enable high speed roll-to-roll manufacturing as well as stamping, blanking or die cutting operations.

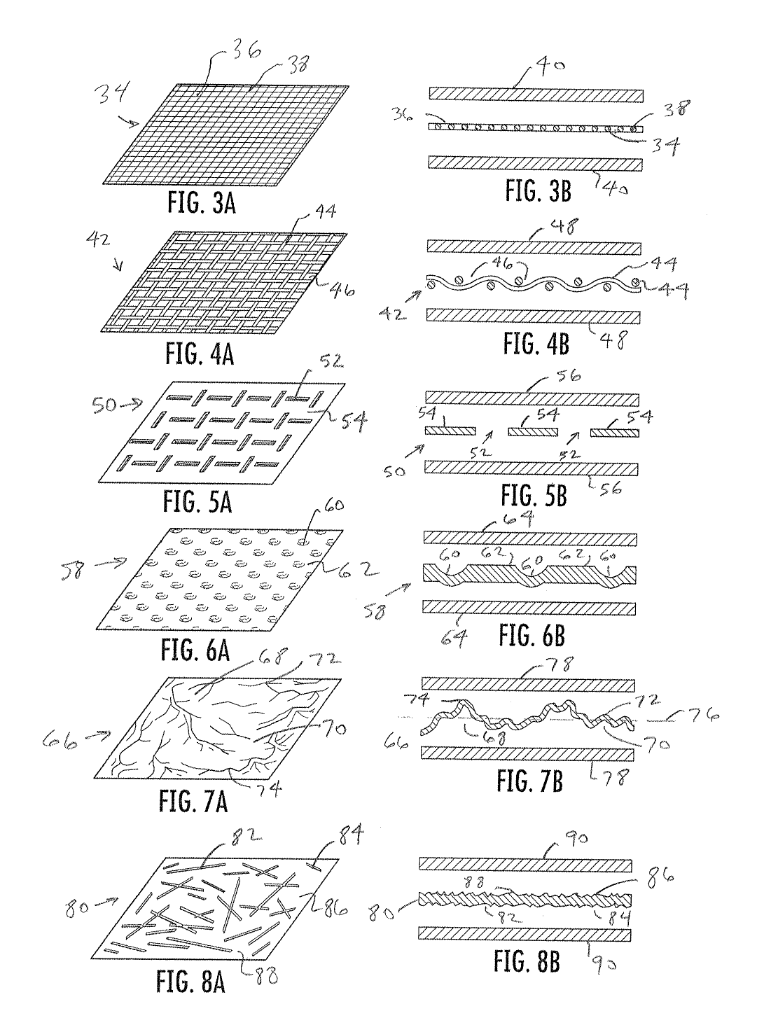

Another advantage of a metal substrate of non-uniform thickness is lower electrical resistivity in the plane of the composite. In fact, the use of a metal/flexible graphite composite provides an improved combination of in-plane electrical and thermal conductivity for a given thickness of separator plate. The substrate sheet can present a non-uniform thickness in various configurations. FIGS. 3-8 include perspective and sectional views of different substrate profiles, illustrating various recess and node arrangements of the non-uniform thickness of substrate sheets according to aspects of the invention. The reference plane of the substrate sheet can be a center plane or one of the surface planes.

As shown in FIGS. 3A-3B, the substrate sheet can be a mesh 34, which provides through hole recesses 36, repeated throughout the mesh 34, but only one of which is numbered to facilitate illustration, interspersed among nodes provided by the webbing 38 of the mesh 34. In the example of FIGS. 3A-3B, the mesh 34 is non-woven, providing nodes that are substantially the same height. In FIG. 3B, the mesh 34 is shown interposed between graphite layers 40 in a not-to-scale spacing. The intervening bonding agent is not shown but is understood to substantially occupy the spacing between the mesh 34 and the graphite layers 40, including extending into one or more of the through hole recesses 36.

FIGS. 4A-4B shows an alternative screen 42 that is woven, with the weft and the warp 44 presenting nodes of different heights among the through hole recesses 46 (again, only one of which is referenced by number) of the screen 42. In FIG. 4B, screen 42 is shown interposed between graphite layers 48 in a not-to-scale spacing. The intervening bonding agent is not shown but is understood to substantially occupy the spacing between the screen 42 and the graphite layers 48, including extending into one or more of the through hole recesses 46.

FIGS. 5A-5B shows the profile of a substrate sheet 50 with perforations 52 (only one of which is numbered) in the sheet to provide through hole recesses among the uniform height nodes, such as surface region 54 of the sheet 50. In FIG. 5B, sheet 50 is shown interposed between graphite layers 56 in a not-to-scale spacing. The intervening bonding agent is not shown but is understood to substantially occupy the spacing between the sheet 50 and the graphite layers 56, including extending into one or more of the through hole recesses 52.

FIGS. 6A-6B shows a substrate sheet 58 with nodes of uniform height and recesses of uniform depth. The recesses can be formed on one side to provide dimples, such as dimple 60, which is representative of the other similarly illustrated dimples, among the nodes, such as the surface region 62. In FIG. 6B, sheet 58 is shown interposed between graphite layers 64 in a not-to-scale spacing. The intervening bonding agent is not shown but is understood to substantially occupy the spacing between the sheet 58 and the graphite layers 64, including extending into one or more of the dimple recesses 60.

FIGS. 7A-7B shows a substrate sheet with nodes of different heights and recesses of different depths. This arrangement of non-uniform thickness can be obtained, for example, from crinkling a foil 66 to form rcesses, such as exemplary recesses 68, 70 and nodes, such as exemplary nodes 72, 74. In FIG. 7B, the foil 66 is shown, with a reference plane 76, interposed between graphite layers 78 in a not-to-scale spacing. The intervening bonding agent is not shown but is understood to substantially occupy the spacing between the foil 66 and the graphite layers 78, including extending into one or more of the recesses, such as the recesses 68, 70.

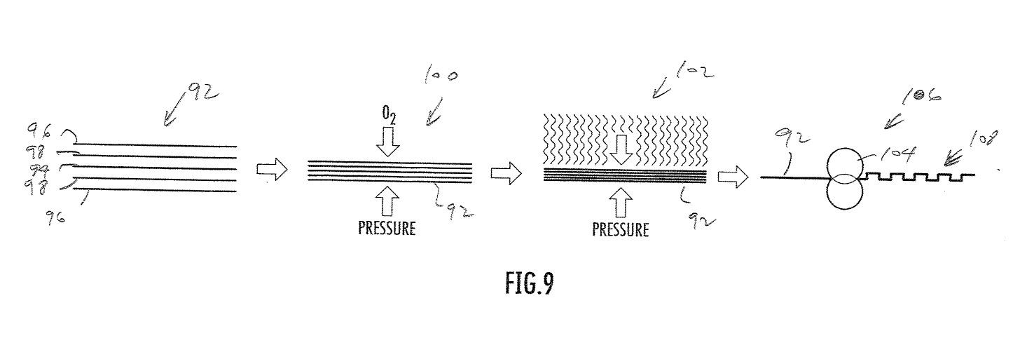

FIGS. 8A-8B shows another substrate sheet with nodes of different heights and recesses of different depths. This arrangement of non-uniform thickness can be obtained, for example, from roughening, etching or scratching a foil or plate 80, resulting in recesses, for example, recesses 82, 84, and nodes, such as nodes 86, 88. The surface roughness per side, or profile, is preferably about one-half of the average foil thickness, i.e. an average foil thickness of 2 mils could have a surface profile of 1 mil. In FIG. 8B, the foil 80 is shown interposed between graphite layers 90 in a not-to-scale spacing. The intervening bonding agent is not shown but is understood to substantially occupy the spacing between the foil 80 and the graphite layers 90, including extending into one or more of the recesses, such as the recesses 82, 84.

In order to bond the substrate of non-uniform thickness to the flexible graphite layers and maximize the through plane conductivity of the composite, a conductive bonding agent or adhesive is used. Typically, a particulate form of carbon is used to impart conductivity to the adhesive. However, due to increased corrosion resistance, graphite particles are preferred over more amorphous forms of carbon.

The conductive adhesive also has a polymeric component, which must withstand the elevated temperatures required for operating high temperature PEM membranes. High temperature PEM membranes typically operate between 120 degrees C. to 160 degrees C., for extended life, but may operate at 190 degrees C. or more for brief periods, or to achieve maximum power. Nominal operating temperature of the separator plates for high temperature PEM fuel cells is between 160 degrees C. to 180 degrees C., yielding the best balance of life and power output.

The polymeric component of the conductive adhesive must protect the metal from corrosion, and should not flake or peel off of the metal surface during fuel cell operation. Large flakes could block flow channels and negatively affect the fuel cell performance and life. With respect to avoiding flaking or peeling, the metal foil is not optimized.

The polymeric component of the conductive adhesive can include any suitable material, such as thermoplastic. Although traditionally used as a coating, the reinforcing layer can be bonded to the flexible graphite layers by application of a thermoplastic followed by curing. For example, the conductive adhesive can include a mixture of epoxy and graphite flakes.

Typically, polymers for high temperature applications operating over 100 degrees C. are selected from thermosets. The preferred polymer however includes a thermoplastic that is normally used as a coating or a matrix material for molded parts. Composite stacks according to aspects of the invention use a thermoplastic polymer as part of the bonding agent, contributing to the formability of the composite stack and addresse the exposure of thermoplastic use in the high temperature fuel cell environment by curing the bonding agent.

The conductive adhesive can be in the form of a powder or a slurry. Although a powder form is preferred for application to a metal mesh substrate, the powder can be more difficult to apply evenly. The use of a mesh substrate can help to distribute the powder evenly.

The thickness of the conductive adhesive may range from 0.0005 inches to 0.01 inches, and may also extend as an interpenetrating network throughout the thickness of a metal mesh substrate. The adhesive may be impregnated into the spaces within the metal mesh, simplifying application of higher viscosity adhesive formulations.

The flexible graphite layer can be formed from graphite adaptable to flex under pressure. The flexible graphite layer can also be formed from polymeric material filled with graphite.

The thickness of a flexible graphite layer can be varied to affect the composite properties. The range of thickness is generally between 0.001 inches to 0.030 inches. A flexible graphite layer thickness of 0.010 to 0.020 inches enables better heat conduction, but may be difficult to form into fine channels through corrugation.

A flexible graphite layer thickness of 0.001 to 0.010 inches improves formability. For example, a corrugated separator of the present invention with a channel height of 0.040 to inches, and a composite thickness of 0.016 inches, has two 0.005 inch thick flexible graphite layers.

Table 1 shows the properties of a separator plate with flexible graphite layers of varying thickness bonded to a reinforcing layer of stainless steel.

Laminar Composite Separator Plate with Stainless Steel

| | | | GTA |
|---|---|---|---|
| Material Property | Units | 316 S.S. | Grafoil |
| Density | g/cc | 7.95 | 1.12 |
| Electrical Resistivity | μOhm- | 75 | 1400 |
| | cm | | |
| Thermal Conductivity | W/m * K | 16 | 150 |

Laminate Construction*

| Thickness (inch) | | | | | Laminate Property** | |
|---|---|---|---|---|---|---|
| 316 | | | Thickness Fraction | | μOhm- | |
| S.S. | Grafoil | Total | 316 S.S. | Grafoil | cm | W/m * K |
| 0 | 0.003 | 0.003 | 0.000 | 1.000 | 1400 | 150 |
| 0.001 | 0.003 | 0.004 | 0.250 | 0.750 | 1069 | 117 |
| 0.002 | 0.003 | 0.005 | 0.400 | 0.600 | 870 | 96 |
| 0.003 | 0.003 | 0.006 | 0.500 | 0.500 | 738 | 83 |
| 0.005 | 0.003 | 0.008 | 0.625 | 0.375 | 572 | 66 |
| 0.01 | 0.003 | 0.013 | 0.769 | 0.231 | 381 | 47 |
| 0.01 | 0 | 0.01 | 1.000 | 0.000 | 75 | 16 |
| 0.001 | 0.006 | 0.007 | 0.143 | 0.857 | 1211 | 131 |
| 0.002 | 0.006 | 0.008 | 0.250 | 0.750 | 1069 | 117 |
| 0.003 | 0.006 | 0.009 | 0.333 | 0.667 | 958 | 105 |
| 0.005 | 0.006 | 0.011 | 0.455 | 0.545 | 798 | 89 |
| 0.01 | 0.006 | 0.016 | 0.625 | 0.375 | 572 | 66 |
| 0.001 | 0.01 | 0.011 | 0.091 | 0.909 | 1280 | 138 |
| 0.002 | 0.01 | 0.012 | 0.167 | 0.833 | 1179 | 128 |
| 0.003 | 0.01 | 0.013 | 0.231 | 0.769 | 1094 | 119 |
| 0.005 | 0.01 | 0.015 | 0.333 | 0.667 | 958 | 105 |
| 0.01 | 0.01 | 0.02 | 0.500 | 0.500 | 738 | 83 |
| 0.001 | 0.02 | 0.021 | 0.048 | 0.952 | 1337 | 144 |
| 0.002 | 0.02 | 0.022 | 0.091 | 0.909 | 1280 | 138 |
| 0.003 | 0.02 | 0.023 | 0.130 | 0.870 | 1227 | 133 |
| 0.005 | 0.02 | 0.025 | 0.200 | 0.800 | 1135 | 123 |
| 0.01 | 0.02 | 0.03 | 0.333 | 0.667 | 958 | 105 |
| 0.001 | 0.04 | 0.041 | 0.024 | 0.976 | 1368 | 147 |
| 0.002 | 0.04 | 0.042 | 0.048 | 0.952 | 1337 | 144 |
| 0.003 | 0.04 | 0.043 | 0.070 | 0.930 | 1308 | 141 |
| 0.005 | 0.04 | 0.045 | 0.111 | 0.889 | 1253 | 135 |
| 0.01 | 0.04 | 0.05 | 0.200 | 0.800 | 1135 | 123 |

*Analysis neglects contributions from conductive adhesive
**In-plane propertie

Table 2 shows the properties of a separator plate with flexible graphite layers of varying thickness bonded to a reinforcing layer of steel.

Laminar Composite Separator Plate with Plain Steel

| | | | GTA |
|---|---|---|---|
| Material Property | Units | Steel | Grafoil |
| Density | g/cc | 7.87 | 1.12 |
| Electrical Resistivity | μOhm-cm | 17 | 1400 |
| Thermal Conductivity | W/m * K | 50 | 150 |

Laminate Construction*

| Thickness (inch) | | | Thickness Fraction | | Laminate Property** | |
|---|---|---|---|---|---|---|
| Steel | Grafoil | Total | Steel | Grafoil | μOhm-cm | W/m * K |
| 0 | 0.003 | 0.003 | 0.000 | 1.000 | 1400 | 150 |
| 0.001 | 0.003 | 0.004 | 0.250 | 0.750 | 1054 | 125 |
| 0.002 | 0.003 | 0.005 | 0.400 | 0.600 | 847 | 110 |
| 0.003 | 0.003 | 0.006 | 0.500 | 0.500 | 709 | 100 |
| 0.005 | 0.003 | 0.008 | 0.625 | 0.375 | 536 | 88 |
| 0.01 | 0.003 | 0.013 | 0.769 | 0.231 | 336 | 73 |
| 0.01 | 0 | 0.01 | 1.000 | 0.000 | 17 | 50 |
| 0.001 | 0.006 | 0.007 | 0.143 | 0.857 | 1202 | 136 |
| 0.002 | 0.006 | 0.008 | 0.250 | 0.750 | 1054 | 125 |
| 0.003 | 0.006 | 0.009 | 0.333 | 0.667 | 939 | 117 |
| 0.005 | 0.006 | 0.011 | 0.455 | 0.545 | 771 | 105 |
| 0.01 | 0.006 | 0.016 | 0.625 | 0.375 | 536 | 88 |
| 0.001 | 0.01 | 0.011 | 0.091 | 0.909 | 1274 | 141 |
| 0.002 | 0.01 | 0.012 | 0.167 | 0.833 | 1170 | 133 |
| 0.003 | 0.01 | 0.013 | 0.231 | 0.769 | 1081 | 127 |
| 0.005 | 0.01 | 0.015 | 0.333 | 0.667 | 939 | 117 |
| 0.01 | 0.01 | 0.02 | 0.500 | 0.500 | 709 | 100 |
| 0.001 | 0.02 | 0.021 | 0.048 | 0.952 | 1334 | 145 |
| 0.002 | 0.02 | 0.022 | 0.091 | 0.909 | 1274 | 141 |
| 0.003 | 0.02 | 0.023 | 0.130 | 0.870 | 1220 | 137 |
| 0.005 | 0.02 | 0.025 | 0.200 | 0.800 | 1123 | 130 |
| 0.01 | 0.02 | 0.03 | 0.333 | 0.667 | 939 | 117 |
| 0.001 | 0.04 | 0.041 | 0.024 | 0.976 | 1366 | 148 |
| 0.002 | 0.04 | 0.042 | 0.048 | 0.952 | 1334 | 145 |
| 0.003 | 0.04 | 0.043 | 0.070 | 0.930 | 1304 | 143 |
| 0.005 | 0.04 | 0.045 | 0.111 | 0.889 | 1246 | 139 |
| 0.01 | 0.04 | 0.05 | 0.200 | 0.800 | 1123 | 130 |

*Analysis neglects contributions from conductive adhesive
**In-plane properties

Table 3 shows the properties of a separator plate with flexible graphite layers of varying thickness bonded to a reinforcing layer of nickel.

Laminar Composite Separator Plate with Nickel

| | | | GTA |
|---|---|---|---|
| Material Property | Units | Nickel | Grafoil |
| Density | g/cc | 8.9 | 1.12 |
| Electrical Resistivity | μOhm-cm | 7 | 1400 |
| Thermal Conductivity | W/m * K | 90.9 | 150 |

Laminate Construction*

| | | | | | Laminate Property** | |
|---|---|---|---|---|---|---|
| Thickness (inch) | | | Thickness Fraction | | μOhm- | |
| Nickel | Grafoil | Total | Nickel | Grafoil | cm | W/m * K |
| 0 | 0.003 | 0.003 | 0.000 | 1.000 | 1400 | 150 |
| 0.001 | 0.003 | 0.004 | 0.250 | 0.750 | 1052 | 135 |
| 0.002 | 0.003 | 0.005 | 0.400 | 0.600 | 843 | 126 |
| 0.003 | 0.003 | 0.006 | 0.500 | 0.500 | 704 | 120 |
| 0.005 | 0.003 | 0.008 | 0.625 | 0.375 | 529 | 113 |
| 0.01 | 0.003 | 0.013 | 0.769 | 0.231 | 328 | 105 |
| 0.01 | 0 | 0.01 | 1.000 | 0.000 | 7 | 91 |
| 0.001 | 0.006 | 0.007 | 0.143 | 0.857 | 1201 | 142 |
| 0.002 | 0.006 | 0.008 | 0.250 | 0.750 | 1052 | 135 |
| 0.003 | 0.006 | 0.009 | 0.333 | 0.667 | 936 | 130 |
| 0.005 | 0.006 | 0.011 | 0.455 | 0.545 | 767 | 123 |
| 0.01 | 0.006 | 0.016 | 0.625 | 0.375 | 529 | 113 |
| 0.001 | 0.01 | 0.011 | 0.091 | 0.909 | 1273 | 145 |
| 0.002 | 0.01 | 0.012 | 0.167 | 0.833 | 1168 | 140 |
| 0.003 | 0.01 | 0.013 | 0.231 | 0.769 | 1079 | 136 |
| 0.005 | 0.01 | 0.015 | 0.333 | 0.667 | 936 | 130 |
| 0.01 | 0.01 | 0.02 | 0.500 | 0.500 | 704 | 120 |
| 0.001 | 0.02 | 0.021 | 0.048 | 0.952 | 1334 | 147 |
| 0.002 | 0.02 | 0.022 | 0.091 | 0.909 | 1273 | 145 |
| 0.003 | 0.02 | 0.023 | 0.130 | 0.870 | 1218 | 142 |
| 0.005 | 0.02 | 0.025 | 0.200 | 0.800 | 1121 | 138 |
| 0.01 | 0.02 | 0.03 | 0.333 | 0.667 | 936 | 130 |
| 0.001 | 0.04 | 0.041 | 0.024 | 0.976 | 1366 | 149 |
| 0.002 | 0.04 | 0.042 | 0.048 | 0.952 | 1334 | 147 |
| 0.003 | 0.04 | 0.043 | 0.070 | 0.930 | 1303 | 146 |
| 0.005 | 0.04 | 0.045 | 0.111 | 0.889 | 1245 | 143 |
| 0.01 | 0.04 | 0.05 | 0.200 | 0.800 | 1121 | 138 |

*Analysis neglects contributions from conductive adhesive
**In-plane properties

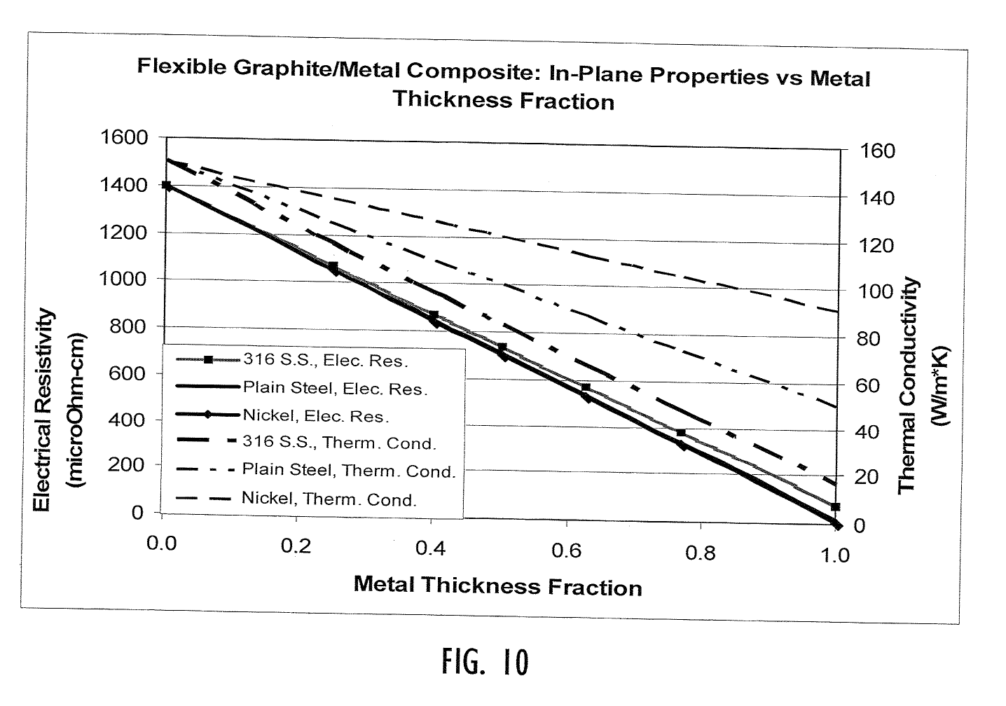

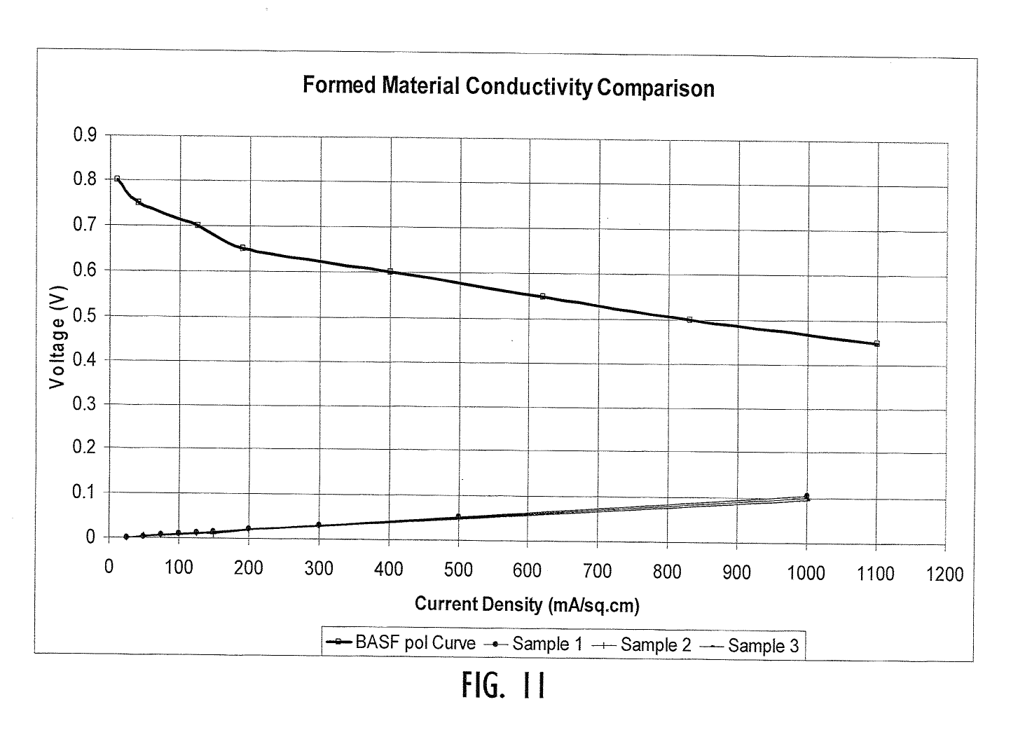

The graph in FIG. 10 illustrates the results from Tables 1 through 3 regarding how the electrical and thermal properties of various separator plates vary with the thickness of the flexible graphite layers.

Referring now to FIG. 9, a composite stack 92 according to aspects of the invention can be formed in the following fashion. The substrate of non-uniform thickness 94 formed from at least one of metal and metal alloys is positioned between the flexible graphite layers 96, formed from the graphite adaptable to flex under pressure or the polymeric material filled with graphite. The flexible graphite layers 96 are bonded to the opposite surfaces of the substrate of non-uniform thickness 94 by a conductive bonding agent 98, which is applied between the flexible graphite layers 96 and the substrate of non-uniform thickness 94. To join the components to form the composite stack 92, the stack 92 is preferably first cured and pressure is applied in a curing step 100 such that the substrate of non-uniform thickness 92 is in contact with the bonding agent 98 and the flexible graphite layers 96 are also in contact with the bonding agent 98. The stack 92 can then be hot pressed in a hot pressing step 102, thereby forcing the flexible graphite layers to the substrate of non-uniform thickness with the bonding agent being sandwiched therebetween to form a unitary composite.

In another method, the bonding agent includes a thermoplastic with graphite particles dispersed within the thermoplastic, which is deposited between the substrate of non-uniform thickness and the flexible graphite layers. The method of deposition can include co-extrusion or calendaring of the bonding agent and the substrate of non-uniform thickness. Additionally, pressure can be applied in the presence of oxygen then hot pressing to cure the thermoplastic bonding agent, thereby forming a unitary composite.

Alluding to both methods described above, the unitary composite 92 can then be fed through a pair of dies 104 in a forming step 108 to deform the composite into a corrugated shape with channels as shown in FIG. 9. The dies 104 may be integral with a corrugation apparatus (not shown) or be separable therefrom without limiting the scope of the invention. The foredm composite 108 is then precut to the desired length. The resulting composite according to aspects of the invention exhibits desirable thermal and electrical conductivity while eliminating the need for high-cost machined graphite plates and metal plates plated with platinum and gold and being easy to manufacture.

Although not intending to limit the scope of the invention, the following examples of composites are provided in order to further illustrate aspects of the present invention. Exemplary composites disclosed herein that provide desirable electrically and thermally conductive properties and that can function as separator plates or other flow field elements for fuel cells are described.

### Example 1

An electrically and thermally conductive composite can be formed from the following components:
i). 316 stainless steel foil, 0.003 inches thick
ii). high temperature conductive adhesive, comprising:
   a). 10 mL part A, MG 832HT epoxy (MG Chemicals)
   b). 5 mL part B, MG 832HT epoxy (MG Chemicals)
   c). 6 grams Asbury #3243 graphite flake (Asbury Graphite)
iii). GTA Grafoil flexible graphite, 0.005 inches thick (Graftech)

A composite comprising the above flexible graphite/conductive adhesive/stainless steel foil/conductive adhesive/flexible graphite is cured under pressure at 180 degrees F. for 1 hour. Passing the above composite through intermeshing splines forms a corrugated separator plate or flow field insert.

### Example 2

An electrically and thermally conductive composite can be formed from the following components:
i). 316 stainless steel 100×100 mesh, 0.0045 inches diameter wire, 30.3% open area
ii). high temperature conductive adhesive, comprising:
   a). 10 mL part A, MG 832HT epoxy (MG Chemicals)
   b). 5 mL part B, MG 832HT epoxy (MG Chemicals)
   c). 6 grams Asbury #3243 graphite flake (Asbury Graphite)
iii). GTA Grafoil flexible graphite, 0.005 inches thick (Graftech)

A composite comprising the above flexible graphite/conductive adhesive/stainless steel mesh/conductive adhesive/flexible graphite is cured under pressure at 180 degrees F. for 1 hour. Passing the above composite through intermeshing splines forms a corrugated separator plate or flow field insert.

Table 4 shows a comparison of the electrical resistance properties between the composite of Example 1 (using metal foil) and the composite of Example 2 (using metal mesh). Comparison of Example 1 and 2 Through-plane Electrical Resistance

Clamping Pressure vs Voltage Drop at 1 Amp/cm2

Voltage Drop (VDC)

| Clamping Pressure (psi) | Example 1 | Example 2 |
|---|---|---|
| 15 | .230 | .150 |
| 30 | .143 | .091 |
| 45 | .126 | .080 |
| 60 | .116 | .074 |
| 75 | .111 | .071 |
| 15 | .157 | .113 |

Table 5 shows the tensile strength, electrical resistivity and thermal conductivity of the composite described by Example 1.

### Comparison of Example 1 Component Properties (In Plane)

Properties of Component Layers in Composite Laminate of Example 1

| | Component | Tensile | Electrical | Thermal |
|---|---|---|---|---|
| Component | Thickness in | Strength | Resistivity | Conductivity |
| Layer Material | Laminate (inch) | (MPa) | (μOhm-cm) | (W/m * K) |
| 316 S.S. | 0.003 | 515 | 75 | 16 |
| GTA Grafoil | 0.010 | 4.5 | 1400 | 150 |

### Example 3

An electrically and thermally conductive composite can be formed from the following components:
High Purity Graphite Flake—Asbury Graphite #3243
PPS Polymer Powder—Chevron Phillips Ryton VI
Propylene Glycol
Triton X-100 surfactant
Stainless Steel Screen—McMaster Carr 9319T41, 0.0026″ wire dia., 37.8% open
Flexible Graphite—Graphtec 0.005″ thick GTA Grafoil

The components are formed into a slurry mix in the following portions: PPS V-1 100 parts per weight (ppw); water, 260 ppw; propylene glycol, 20 ppw; wetting agent (Triton X-100), 4 ppw; graphite, 100 ppw. The components are placed in a ball mill with 5/32″ 302S.S. grinding media at 30 rpm for 12 hours.

To determine approximate amount of powder mixture needed for a given screen size, as an example, Powder mixture density (cured)=(1.35 g/cc+2.23 g/cc)/2=1.79 g/cc, Overall mesh thickness=2*wire dia.=0.0052″=0.0132 cm, % open area of mesh=37.8%=0.378, Minimum mixture needed [g]=sample area(2.375×2×2.54̂2 cm2)*0.0132 cm*0.378*1.79 g/cc=0.2737 g

This represents 0.0089 g of powder mix per sq.cm of 0.0026″ mesh. Given the mix ratios for the slurry it converts into 0.3542 g of slurry mix per sq.cm.

The grafoil pre-baked at 390 deg.C. in an air circulating oven for 20 minutes to degrade any attached oils and remove any trapped gases. The stainless steel screen cleaned in a bath containing citrisurf solution and rinsed thoroughly in deionized water.

The screen substrate in placed onto a grafoil sheet. The powder or slurry mix is evenly spread. The second grafoil layer is added. The laminate stack is cured in an air circulating furnace for 35 minutes at 375*C. The stack is then hot pressed between two stainless steel plates at 1000 psi and 280*C for 30 seconds. The stack is cooled down under weight.

### Example 4

Another electrically and thermally conductive composite can be formed from the following components:
High Purity Graphite Flake—Asbury Graphite #3243
PPS Polymer Powder—Chevron Phillips Ryton VI
Stainless Steel Screen—McMaster Carr 9319T41, 0.0026″ wire dia., 37.8% open
Flexible Graphite—Graphtec 0.005″ thick GTA Grafoil

The dry powder can be a combination of a thermoset/thermoplastic polymer mixed with fine graphite powder. Such binding matrix is designed to withstand operation conditions and environment. The mix is preferably constituted of PPS V-1 (1 ppw) and graphite (1 ppw), mixed in a rotating drum at 50 rpm for 1 hour.

The calculation of the appropriate amount of powder mixture needed for a given screen size can be made as in Example 3 above. The further steps in Example 3 can be used in fabricating the composite stack.

Supporting Data

Various tests have been performed on finished laminate having aspects of the invention. The tests include electrical testing on several samples and incorporated into a 4-cell fuel cell system.

For testing samples, a current is introduced through gold coated copper plates and a voltage drop is measured across the laminate. Standardizing compression of 88 psi (250 kg over a 45.58 sq.cm area), a given contact area and introduced current; a chart of voltage drop vs. current density is made. FIG. 11 shows a BASF polarization curve and Voltage drop vs. Current density of corrugated laminate samples for use in a 4-cell fuel cell. Given an internal physical fuel cell stack-up where all components are electrically in series, this chart helps estimate cell resistance and predict cell performance. The added thermal properties and contact area from a rough surface are not part of this test.

As with any composite material, pressure and temperature will also affect its material properties. The following charts portray how the conductivity of these laminates rise with increased pressure. As reflected in the first two sections of the table, voltage drop measurements were taken twice, in two different places of the laminate, at different pressures and a varying current density over a 45.58 sq.cm area (3 in diameter). The last section compares the accuracy and repeatability of the test.

| | | TOP | | | Middle | | |
|---|---|---|---|---|---|---|---|
| mA per | | 100 psi | 200 psi | 300 psi | 100 psi | 200 psi | 300 psi |
| sq. cm | Amperage | V drop 1 | V drop 2 | V drop 3 | V drop 1 | V drop 2 | V drop 3 |
| Laminates | | | | | | | |
| Conductivity | | | | | | | |
| Apparatus TRIAL 1 | | | | | | | |
| 25 | 1.2 | 0 | 0 | 0 | 0 | 0 | 0 |
| 50 | 2.3 | 0.003 | 0 | 0 | 0.003 | 0 | 0 |
| 75 | 3.4 | | | | | | |
| 100 | 4.6 | | | | | | |
| 125 | 5.7 | | | | | | |
| 150 | 6.8 | 0.007 | 0.0052 | 0.0047 | 0.0066 | 0.0045 | 0.0041 |
| 200 | 9.1 | | | | | | |
| 300 | 13.6 | | | | | | |
| 500 | 22.8 | 0.0313 | 0.0227 | 0.0207 | 0.0262 | 0.0207 | 0.0169 |
| 1000 | 45.6 | 0.0629 | 0.0444 | 0.0408 | 0.0513 | 0.0411 | 0.0369 |
| Laminates | | | | | | | |
| Conductivity | | | | | | | |
| Apparatus TRIAL 2 | | | | | | | |
| 25 | 1.2 | 0 | 0 | 0 | 0 | 0 | 0 |
| 50 | 2.3 | 0 | 0 | 0 | 0 | 0 | 0 |
| 75 | 3.4 | | | | | | |
| 100 | 4.6 | | | | | | |
| 125 | 5.7 | | | | | | |
| 150 | 6.8 | 0.007 | 0.0052 | 0.0046 | 0.0067 | 0.0048 | 0.0041 |
| 200 | 9.1 | | | | | | |
| 300 | 13.6 | | | | | | |
| 500 | 22.8 | 0.0312 | 0.0227 | 0.0207 | 0.0262 | 0.0209 | 0.0173 |
| 1000 | 45.6 | 0.0631 | 0.0474 | 0.0415 | 0.0516 | 0.0418 | 0.0373 |
| Laminates | | | | | | | |
| Test Variability | | | | | | | |
| 25 | 1.2 | 0.0% | 0.0% | 0.0% | 0.0% | 0.0% | 0.0% |
| 50 | 2.3 | 0.0% | 0.0% | 0.0% | 0.0% | 0.0% | 0.0% |
| 75 | 3.4 | | | | | | |
| 100 | 4.6 | | | | | | |
| 125 | 5.7 | | | | | | |
| 150 | 6.8 | 0.0% | 0.0% | 1.1% | −0.8% | −3.2% | 0.0% |
| 200 | 9.1 | | | | | | |
| 300 | 13.6 | | | | | | |
| 500 | 22.8 | 0.2% | 0.0% | 0.0% | 0.0% | −0.5% | −1.2% |
| 1000 | 45.6 | −0.2% | −3.3% | −0.9% | −0.3% | −0.8% | −0.5% |

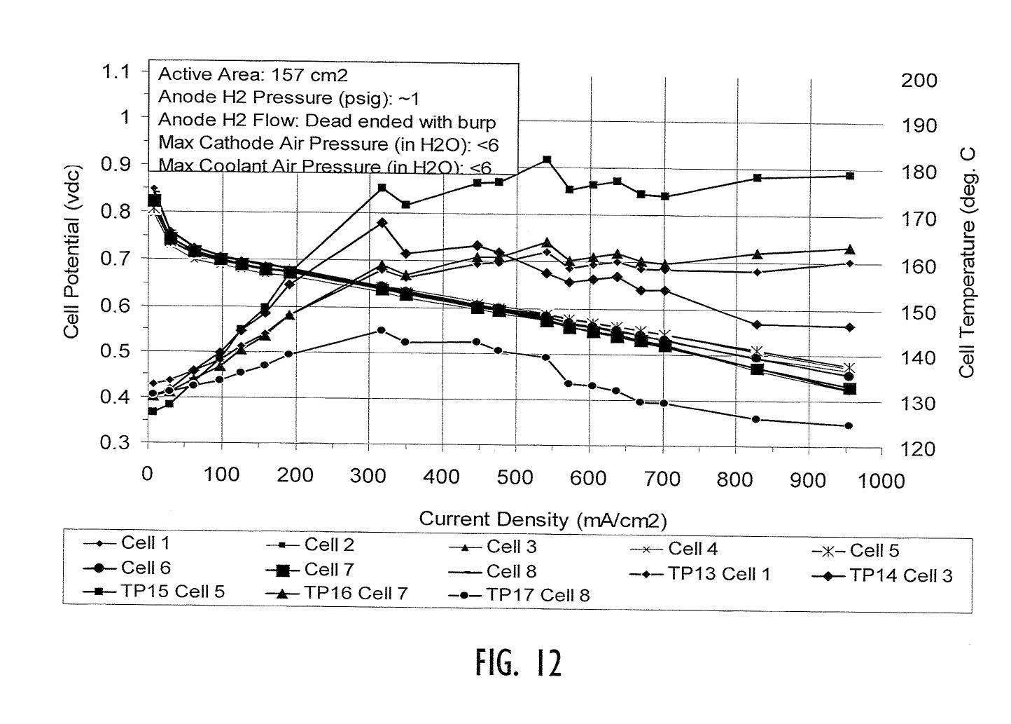

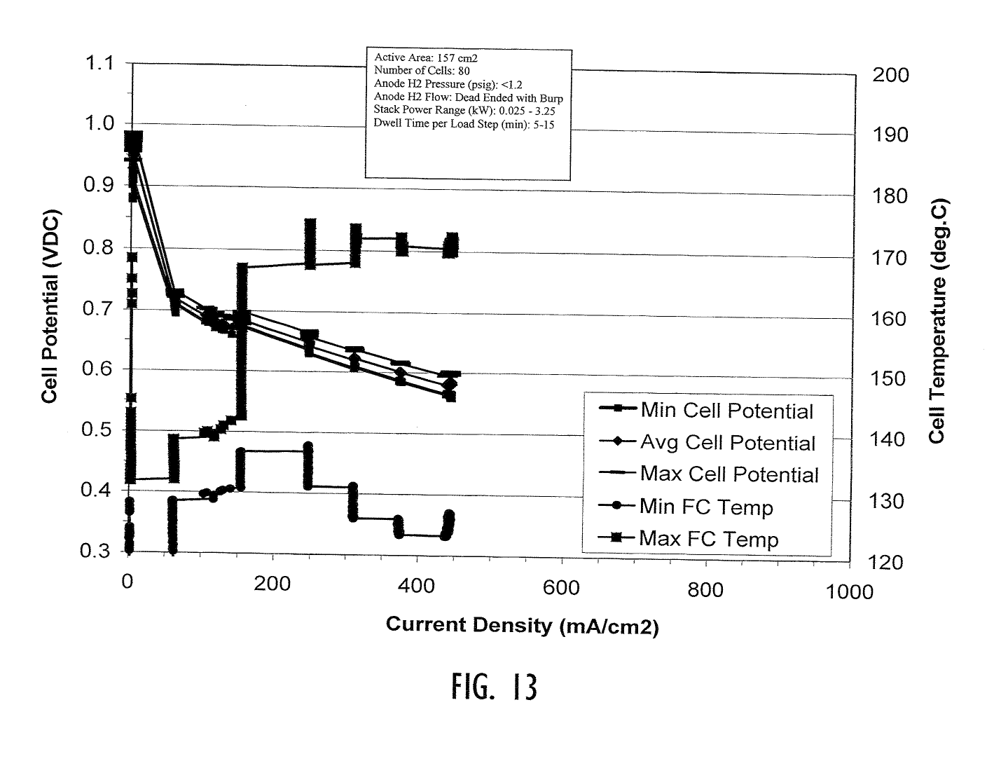

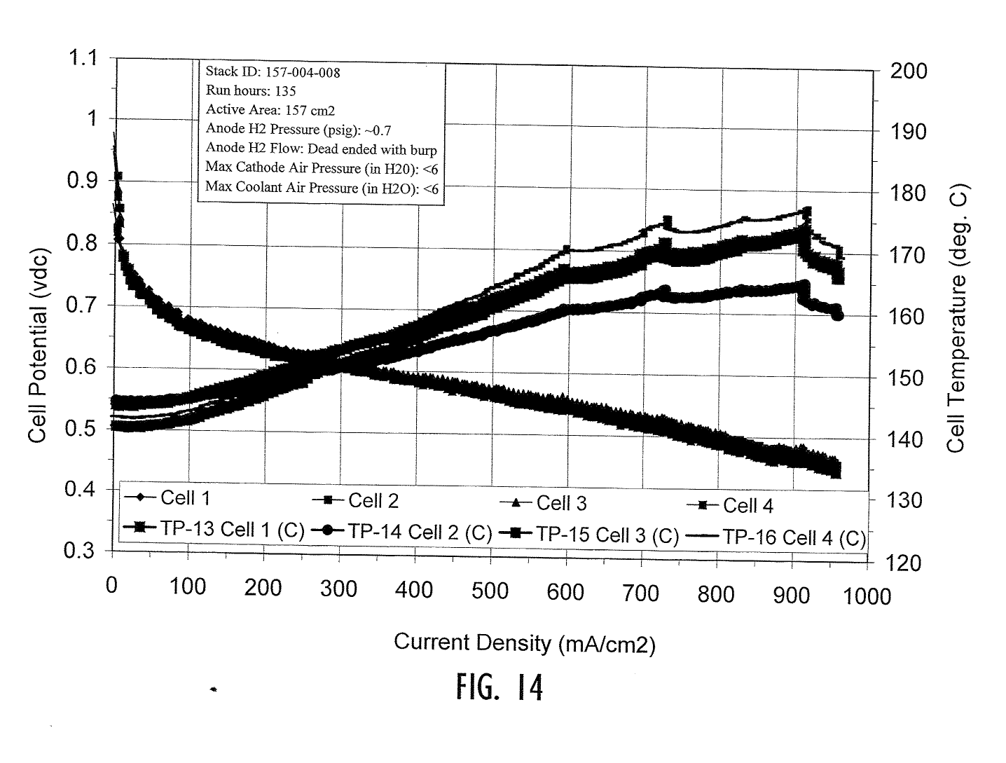

Composite stacks according to the invention were also tested in a four cell fuel cell stack. For comparison, FIG. 12 is a graph of test results for an air-cooled 8-cell stack with metal plates. Individual cell temperatures were between 125 deg.C. to 180 deg.C. during polarization to 950 mA/cm2 with H2/air. FIG. 13 shows test results for a 3 kW air-cooled 80-cell stack with metal plates. Individual cell temperatures were between 122 deg.C. to 175 deg.C. during polarization to 450 mA/cm2 with H2/air.

FIG. 14 shows the test results for an air-cooled 4-cell stack with plates using composite stacks according to the invention. Individual cell temperatures were between 160 deg.C. to 170 deg.C. during polarization at 950 mA/cm2 with H2/air. A comparison of the results of the fuel cell stacks with metal plates in FIGS. 12 and 13 with the results in FIG. 14 shows improved heat transfer.

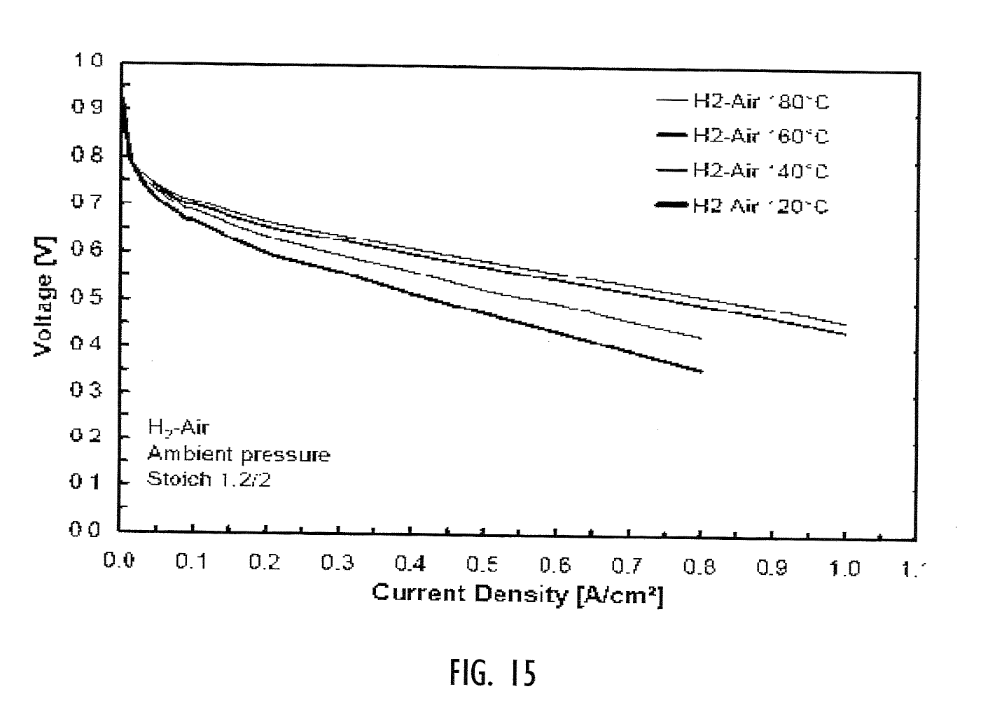

FIG. 15 shows single cell performance as a function of cell temperature with H2/Air.

The foregoing description of preferred embodiments of the invention have been presented for the purposes of illustration. The description is not intended to limit the invention to the precise forms or methodologies disclosed. Indeed, modifications and variations will be readily apparent from the foregoing description. Accordingly, it is intended that the scope of the invention not be limited by the detailed description provided herein.

What is claimed is:

1. A fuel cell composite flow field element comprising:
a conductive substrate sheet having a series of recesses interspaced among outer surface nodes, thereby providing a non-uniform thickness;
an electrically conductive bonding agent applied to the substrate; and
a flexible graphite layer bonded to one side of the substrate,
said fuel cell composite flow field element providing at least one flow channel.

2. The fuel cell composite flow field element according to claim 1, wherein the nodes are substantially the same height relative to a reference plane of the substrate sheet.

3. The fuel cell composite flow field element according to claim 1, wherein some of the nodes have different heights than the heights of other nodes relative to a reference plane of the substrate sheet.

4. The fuel cell composite flow field element according to claim 1, wherein the recesses have substantially the same depth relative to a reference plane of the substrate sheet.

5. The fuel cell composite flow field element according to claim 1, wherein some of the recesses have different depths than the depths of other recesses relative to a reference plane of the substrate sheet.

6. The fuel cell composite flow field element according to claim 1, wherein the recesses are dimples in the substrate sheet.

7. The fuel cell composite flow field element according to claim 1, further comprising a second flexible graphite layer bonded to an opposite side of the substrate sheet.

8. The fuel cell composite flow field element according to claim 7, wherein the recesses are through-perforations in the sheet.

9. The fuel cell composite flow field element according to claim 7, wherein the substrate sheet is a screen, the recesses are through holes of the screen and the nodes are provided by the webbing of the screen.

10. The fuel cell composite flow field element according to claim 7, wherein the substrate sheet is a woven mesh, the recesses are through holes of the mesh and the nodes are provided by the weave of the mesh.

11. The fuel cell composite flow field element according to claim 10, wherein the mesh is metal.

12. The fuel cell composite flow field element according to claim 10, wherein the metal mesh has a thickness in the range of 0.001 inches to 0.01 inches.

13. The fuel cell composite flow field element according to claim 1, wherein the bonding agrent is co-extruded with the metal mesh.

14. The fuel cell composite flow field element according to claim 1, wherein the bonding agent is applied as a powder.

15. The fuel cell composite flow field element according to claim 1, wherein the bonding agent powder is cured after application.

16. The fuel cell composite flow field element according to claim 1, wherein the bonding agent thickness is thinner on the nodes than in the recesses.

17. The fuel cell composite flow field element according to claim 1, wherein the flow field element is a separator plate.

18. The fuel cell composite flow field element according to claim 1, wherein the substrate comprises metal or metal alloy.

19. The fuel cell composite flow field element according to claim 1, wherein the substrate of non-uniform thickness comprises woven or non-woven carbon fibers.

20. The fuel cell composite flow field element according to claim 1, wherein the electrically conductive bonding agent comprises a polymeric component and carbon particles, wherein the carbon particles are dispersed within the polymeric component.

21. The fuel cell composite flow field element according to claim 1, wherein the polymeric component comprises a cured thermoplastic.

22. The fuel cell composite flow field element according to claim 1, wherein the polymeric component has a continuous use temperature above 190 degrees C.

23. The fuel cell composite flow field element according to claim 1, wherein the flow field element has a corrugated cross section.

24. The fuel cell composite flow field element according to claim 1, wherein the flow field element is an MEA support plate and the flow channel is a fluid port through the plane of the support plate.

25. The fuel cell composite flow field element according to claim 1, wherein the flow field element is a corrugated flow field insert.

26. The fuel cell composite flow field element according to claim 1, wherein the flow field element is a separator plate and the flow channel is a fluid port through the plane of the support plate.

27. A method for making a fuel cell composite flow field element, said method comprising the steps of:
applying an electrically conductive bonding agent to a flexible graphite layer;
placing a conductive substrate sheet having a series of recesses interspaced among outer surface nodes, thereby providing a non-uniform thickness on to the flexible graphite layer;
applying an electrically conductive bonding agent to the substrate;
placing a second flexible graphite layer over the substrate sheet, to form a composite stack;
curing said composite stack;
hot pressing the cured composite stack; and
cooling the composite stack under weight to room temperature.

28. The method according to claim 27, wherein the bonding agent includes a combination of PPS polymer powder (100 ppw); water (260 ppw); propylene glycol (20 ppw); wetting agent (4 ppw) and graphite (100 ppw).

29. The method according to claim 27, wherein the substrate sheet is a metal screen having a webbing dimension and an opening percentage of opening area to total area; and the minimum quantity of bonding agent is calculated in mass based on the product of bonding agent cured density average, the webbing dimension, the opening percentage and substrate sheet total area.

30. The method according to claim 27, wherein the curing step includes heating the composite stack to about 375 degrees C. for about 35 minutes in an air circulating heating environment.

31. The method according to claim 27, wherein the hot pressing step includes pressing the composite stack between two steel plates at about 1000 psi and about 280 degrees C. for about 30 seconds.

32. The method according to claim 27, wherein the step of applying the electrically conductive bonding agent to the substrate includes co-extruding the bonding agent with the substrate.
